(19) United States
(12) Patent Application Publication
(10) Pub. No.: US 2019/0005539 A1
(43) Pub. Date: Jan. 3, 2019

(54) Serving Ads to Social Networks And Other Websites Based On Account-Holder Data

(71) Applicant: David Peter Pitinga, Mountain View, CA (US)

(72) Inventor: David Peter Pitinga, Mountain View, CA (US)

(21) Appl. No.: 14/246,099

(22) Filed: Apr. 6, 2014

Related U.S. Application Data
(60) Provisional application No. 61/810,112, filed on Apr. 9, 2013.
(60) Provisional application No. 61/813,447, filed on Apr. 18, 2013.

(51) Int. Cl. G06Q 30/02; G06Q 50/00

(52) U.S. Cl. CPC G06Q 30/0255; G06Q 50/01

(57) ABSTRACT

Data associated with an online ad is transmitted over a network from an ad-serving service to a financial-services website that maintains a payment account for each of a plurality of account-holder members of a social-networking website. Each of the plurality of account-holder members has expressly given the financial-services website limited authority to use data associated with a payment account for the account-holder member to target ads on the social-networking website without sharing the data associated with the payment account with the social-networking website. Software at the social-networking website receives data from the financial-services website that includes one or more account-holder members who have been identified as potential targets for the online ad. Then the software at the social-networking website presents the online ad through a graphical user interface (GUI) to at least one of the account-holder members who have been identified as potential targets for the online ad.

### RELATED APPLICATIONS

This application claims priority to U.S. Provisional Patent Application No. 61/810,112, entitled, “Serving Ads to Social Networks and Other Websites Based on Cardholder Data” filed on Apr. 9, 2013, and U.S. Provisional Patent Application No. 61/813,447, entitled, “Serving Ads to Social Networks and Other Websites Based on Account-Holder Data” filed on Apr. 18, 2013. The disclosures of both of those provisional applications are incorporated herein by reference for all purposes.

### BACKGROUND

People are beginning to spend as much time viewing and listening to content on social and interest networks and content websites as they spend viewing and listening to content on television. Such viewing and listening habits present an opportunity for advertising that is much more targeted to the interests of particular users than television advertising.

However, online signals such as likes and shares on social and interest networks and comments and page-views on content websites are not always good indicators of user interest for purposes of targeting advertisements. For example, a user might like a piece of content posted by a friend of the user on a social network solely for social purposes, e.g., to be friendly, though the user is actually ambivalent or dislikes the piece of content. Or a user might share an online ad posted by a retailer or service provider because the user aspires to the lifestyle portrayed in the online ad, but is unable to afford the product or service advertised.

A user's purchase history is probably a better indicator of user interest for purposes of targeting advertisements. But users tend to regard many of the details (e.g., the cost or source of a good or service purchased, the financing involved, whether a good is used, etc.) of their purchase histories as private. And consequently, those details are usually stored offline or online in emails (where they might still be subject to anonymous algorithmic analysis and used for targeting advertisements, e.g., by email services such as Gmail).

Online retailers or service providers have access to details of a user's purchase history, but usually only insofar as it involves transactions with the online retailer or service provider.

Financial-services providers (such as issuers of debit or credit cards or providers of electronic-payment services) might have access to a fuller purchase history for a user. But users typically do not spend much time on websites for financial-services providers, for various reasons, including security (e.g., sessions with such websites time out quickly to prevent online and offline eavesdropping).

### SUMMARY

In an example embodiment, a computer-implemented method is described. According to the method, data associated with an online ad is transmitted over a network from an ad-serving service to a financial-services website that maintains a payment account for each of a plurality of account-holder members of a social-networking website. Each of the plurality of account-holder members has expressly given the financial-services website limited authority to use data associated with a payment account for the account-holder member to target ads on the social-networking website without sharing the data with the social-networking website. Software at the social-networking website receives data from the financial-services website that includes one or more account-holder members who have been identified as potential targets for the online ad. Then the software at or distributed by the social-networking website presents the online ad through a graphical user interface (GUI) to at least one of the account-holder members who have been identified as potential targets for the online ad.

In another example embodiment, an apparatus is described, namely, computer-readable storage media that persistently store one or more programs. Pursuant to the programs, data associated with an online ad is transmitted over a network from an ad-serving service to a financial-services website that maintains a payment account for each of a plurality of account-holder users of a content website. Each of the plurality of account-holder users has expressly given the financial-services website limited authority to use data associated with a payment account for the account-holder user to target ads on the content website without sharing the data with the content website. Then pursuant to the programs, the content website receives data from the financial-services website that includes one or more account-holder users who have been identified as potential targets for the online ad. And the content website presents the online ad through a graphical user interface (GUI) to at least one of the account-holder users who have been identified as potential targets for the online ad.

Another example embodiment also involves a computer-implemented method. According to the method, data associated with an online ad is received over a network at a financial-services website that maintains a payment account for each of a plurality of account-holder members of a social-networking website. Each of the plurality of account-holder members has expressly given the financial-services website limited authority to use data associated with a payment account for the account-holder member to target ads on the social-networking website without sharing the data with the social-networking website. Software at the financial-services website determines one or more account-holder users who have been identified as potential targets for the online ad, based at least in part on a similarity measure that takes as input the data associated with the online ad and the data associated with the payment accounts. Then the software on the financial-services website transmits to the social-networking website a ranking of the one or more account-holder members who have been identified as potential targets for presentation of the online ad.

Other aspects and advantages of the inventions will become apparent from the following detailed description, taken in conjunction with the accompanying drawings, which illustrate by way of example the principles of the inventions.

### BRIEF DESCRIPTION OF THE DRAWINGS

FIG. 1A is a diagram that illustrates an architecture for serving ads on a social-networking or content website without its own ad-serving service, in accordance with an example embodiment.

FIG. 1B is a diagram that illustrates an architecture for serving ads on a social-networking or content website with an ad-serving service, in accordance with an example embodiment.

FIG. 2 is a flowchart diagram that illustrates a process for serving ads on a social-networking website based on data associated with a payment account maintained by a financial-services website, in accordance with an example embodiment.

FIG. 3 is a flowchart diagram that illustrates a process for identifying targets for ads on a social-networking website based on data associated with a payment account maintained by a financial-services website, in accordance with an example embodiment.

FIG. 4 is a dialog in a graphical user interface (GUI) that might be used by a financial-services website to obtain limited authority to use data associated with a payment account for an account-holder member of a social-networking website, in accordance with an example embodiment.

FIG. 5A is a GUI view, including an online ad, for a profile on a social-networking website, in accordance with an example embodiment.

FIG. 5B is a GUI view, including an online ad, for search results on a social-networking website, in accordance with an example embodiment.

FIG. 6 is a GUI view, including an online ad, for a timeline or stream on a social-networking website, in accordance with an example embodiment.

FIG. 7 is a flowchart diagram that illustrates a process for serving ads on a content website based on data associated with a payment account maintained by a financial-services website, in accordance with an example embodiment.

FIG. 8 is a flowchart diagram that illustrates a process for identifying targets for ads on a content website based on data associated with a payment account maintained by a financial-services website, in accordance with an example embodiment.

FIG. 9 is a GUI view, including an online ad, for a content stream on a content website, in accordance with an example embodiment.

### DETAILED DESCRIPTION

In the following description, numerous specific details are set forth in order to provide a thorough understanding of the exemplary embodiments. However, it will be apparent to one skilled in the art that the example embodiments may be practiced without some of these specific details. In other instances, process operations and implementation details have not been described in detail, if already well known.

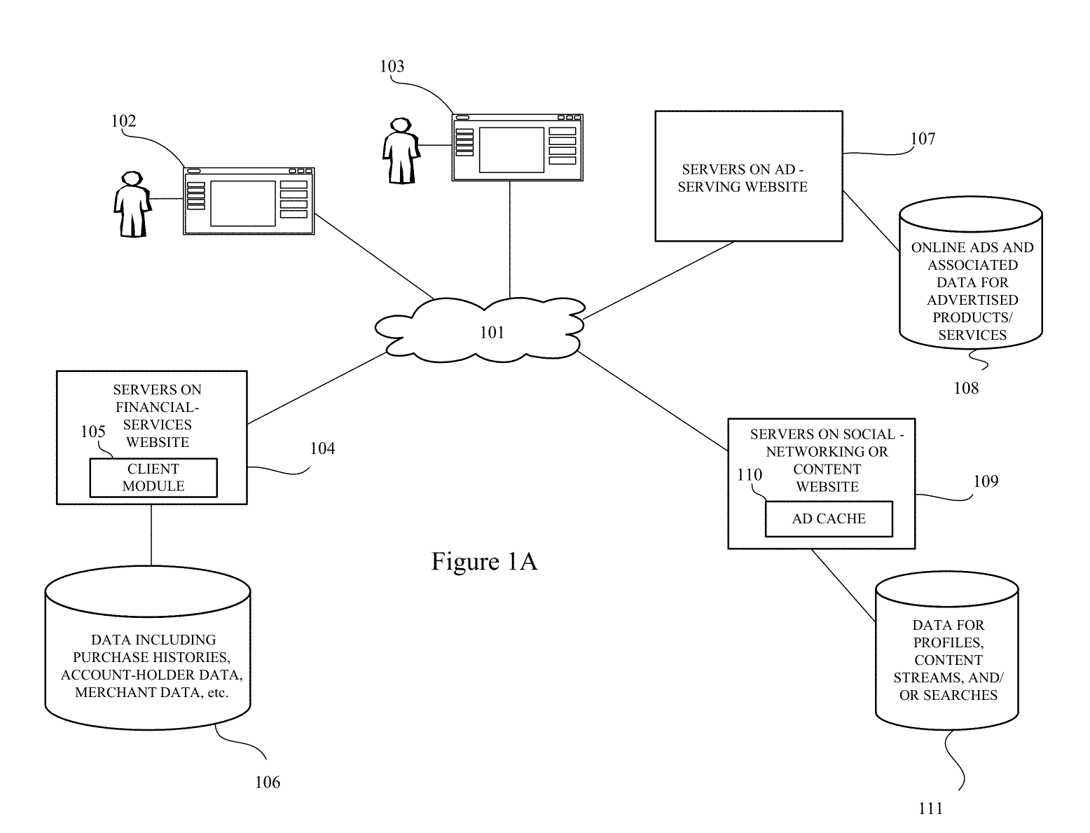

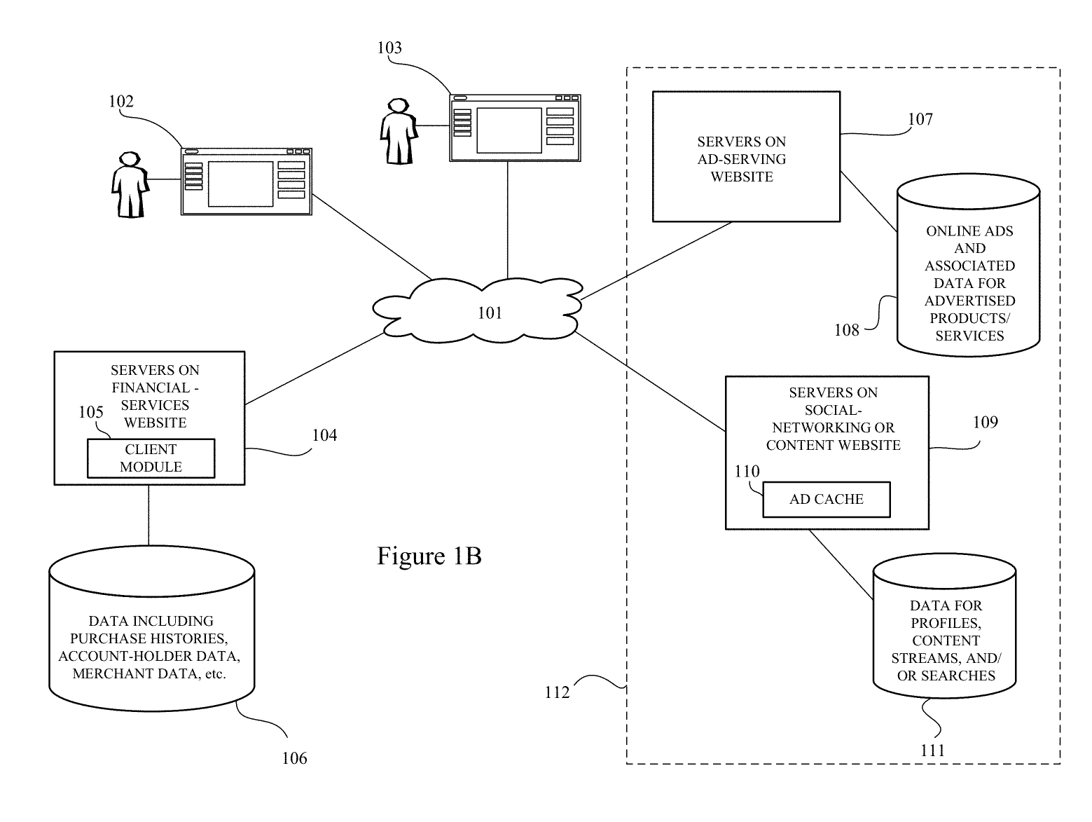

FIG. 1A is a diagram that illustrates an architecture for serving ads on a social-networking or content website without its own ad-serving service, in accordance with an example embodiment. As depicted in this figure, a personal computing device 102, operated by a social-network member or content-site user, is connected by a network 101 (e.g., a wide area network (WAN) including the Internet, which might be wireless in part or in whole) with a financial-services website 104 (e.g., a website such as PayPal or CitiCard) and a website 109 hosting a social network (e.g., a social-networking website such as Facebook) or a content website (e.g., Yahoo! or the New York Times). As used here and elsewhere in this disclosure, the term “social-networking website” is to be broadly interpreted to include, for example, any social-media website (such as YouTube), any interest-networking website (such as Twitter), and any website that enables its users to selectively access (e.g., according to a contact list, buddy list, social graph, interest graph, or other access control list (ACL)) content in each other's profiles and/or selectively broadcast content to or subscribe to content from each other's content streams. The term also includes any website that enables its users to selectively communicate (e.g., according to a contact list, buddy list, social graph, interest graph, spam or other email filter, blacklist, whitelist, or other ACL) with each other (e.g., using a messaging protocol such as email, instant messaging, short message service (SMS), etc.).

Also connected to network 101 is a personal computing device 103, operated by an advertiser and a website 107 which hosts an ad-serving service.

Either or both of the personal computing devices 102 and 103 might be (a) a laptop or other personal computer or (b) a mobile device such as a smartphone, (e.g., Android or iPhone), a tablet computer (e.g., iPad or Kindle), etc. In an example embodiment, each of the websites 104, 107, and 109 might be composed of a number of servers connected by a network (e.g., a local area network (LAN) or a WAN) to each other in a cluster or other distributed system which might execute cloud platform software. The servers in website 104, 107, and 109 might also be connected (e.g., by a storage area network (SAN)) to persistent storages 106, 108, and 111, respectively. In an example embodiment, persistent storages 106, 108, and 111 might include flash memory and/or a redundant array of independent disks (RAID).

Persistent storage 106 might be used to store algorithms (e.g., accounting algorithms and algorithms to generate account-holder members or users for the targeting of online ads as described below) and data related to payment accounts (e.g., associated with debit, credit, or other bank cards, bank accounts, electronic-payment services, mobile-payment services, etc.), including purchase histories, account-holder data (e.g., including user profile/history data), merchant data (e.g., including entity profile/history data), etc. In an example embodiment, some or all of this data might be accessed by client module 105 (e.g., software, firmware, and/or hardware) on financial-services website 104, when determining potential targets for online ads (e.g., received from ad-serving website 107) to be served on social-networking or content website 109. The client module 105 might be distributed from ad-serving website 107 or social-networking and/or content website 109, in example embodiments. Alternatively, financial-services website 104 might provide its own module (e.g., software, firmware, and/or hardware) in whole or in part for determining potential targets for online ads (e.g., received from ad-serving website 107) to be served on social-networking or content website 109.

Persistent storage 108 might be used to store online ads for products and/or services and associated data for the online ads. In an example embodiment, the data associated with an online ad might be entered by an advertiser using a graphical user interface (GUI) provided by the ad-serving website 107. In an example embodiment, this data might be tailored (or structured) to match the data stored by the financial-services website 104 in persistent storage 106. For example, if the data stored by the financial-services services website 104 in persistent storage 106 includes data describing purchases by price, date, and merchant, the data associated with an online ad might include, in addition to an identifier: (1) the price of the product or service advertised, (2) the useful or mean/median life or duration of the product or service advertised, including service agreements associated with the product advertised; (3) merchants (e.g., at a geographic location frequented by an account-holder member or user) who sell (a) the product or service advertised, (b) competitive products and services (e.g., as identified by a recommender system), and/or (c) complementary products and services (e.g., as identified by a recommender system). It will be appreciated that such tailoring (or structuring) might be encouraged or enforced through a GUI on the ad-serving website 107 that integrates or otherwise couples (e.g., through web APIs) with software on the financial-services website 104, e.g., client module 105.

It will also be appreciated that in an example embodiment, the amount of tailoring (or structuring) tends to be related to the amount and/or structure of the data associated with payment accounts that is available to financial-services website 104. So for example, if the account-holders and merchants who use financial-services website 104 allow the website to gather a relatively large amount of unstructured data about them (e.g., at the financial-services website 104 or received from ad-serving website 107 and/or social-networking or content website 109), the data associated with an online ad might be relatively untailored (or structured), e.g., all or some of a textual product specification for (a) the product advertised in the online ad, (b) a competitive product, or (c) a complimentary product or service.

Persistent storage 111 might be used to store data (including content) associated with profiles, streams, and searches on social-networking or content website 109. In an example embodiment, persistent storage 111 might also be used to store online ads for serving on social-networking or content website 109 that have been received from ad-serving website 107 or potential targets for the online ads received from financial-services website 104. In an example embodiment, ad-serving website 107 might transmit at approximately the same time (a) an online ad and its identifier to social-networking or content website 109 and (b) data associated with the online ad and its identifier to financial-services website 104. In order to improve performance and/or reduce latency, the online ad might be cached in memory cache 110 in volatile memory on the servers (e.g., using (a) an in-memory database or main memory database system (MMDB) or (b) a hybrid in-memory database that also uses persistent storage) at the social-networking or content website 109, until the potential targets for the online ad are received from financial-services website 104 for presentation of the online ad.

The architectures shown in FIG. 1A culminate with the presentation of an online ad through a social-networking or content website 109. However, that architecture is illustrative rather than a limiting example. Other websites (e.g., search engines, online retailers, online-auction websites, gaming websites, etc.) might be used to present the online ad. It will be appreciated that the functionality described in this disclosure might be used in hybrid ad-serving to supplement query-based ad-serving (e.g., in search results produced by a search engine) or to supplement tracking-cookie ad-serving. The functionality described in this disclosure might also be used to supplement a recommender system on a website such Amazon or Netflix.

FIG. 1B is a diagram that illustrates an architecture for serving ads on a social-networking or content website with an ad-serving service, in accordance with an example embodiment. As depicted in this diagram, a conglomerate website 112 includes both an ad-serving website 107 with persistent storage 108 and a social-networking or content website 109 with persistent storage 111. It will be appreciated that in an example embodiment where website 109 is a social-networking website (such as Facebook), conglomerate website 112 might transmit social-networking data to financial-services website 104, in addition to data associated with an online ad. Such social-networking data might include (a) profile, stream, or search data for a member who is an account-holder (e.g., including personalization data, signals such as likes, shares, page or image views, comments, etc.) and/or (b) profile, stream, or search data for an entity who is a merchant, in an example embodiment. Likewise, in an example embodiment an example embodiment where website 109 is a content website (such as Yahoo!), conglomerate website 112 might transmit relevance-feedback data for users to financial-services website 104 (e.g., including personalization data, signals such as likes, shares, page or image views, comments, etc.).

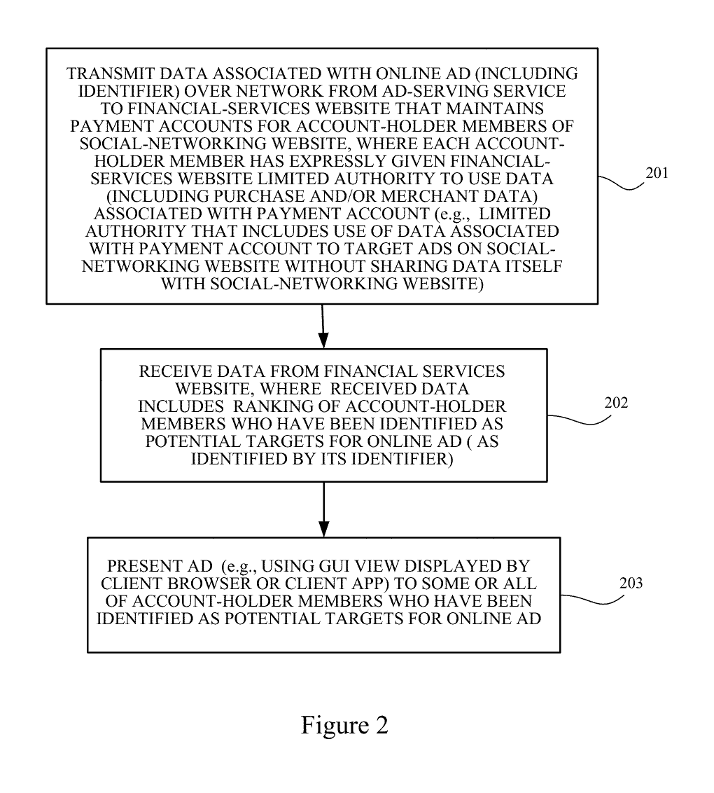

FIG. 2 is a flowchart diagram that illustrates a process for serving ads on a social-networking based on data associated with a payment account maintained by a financial-services website, in accordance with an example embodiment. In an example embodiment, all of the operations in the process might be performed by software running on or distributed by (e.g., a client application or app) a social-networking website, e.g., a social-networking website with an ad-serving service as depicted in FIG. 1B. In an alternative example embodiment, the first operation in the process shown in FIG. 2 might be performed by software running on an ad-serving website which is not a part of a social-networking website, as depicted in FIG. 1A. In that example embodiment, the second and third operations might be performed (a) by software running on and/or distributed by a social-networking website or (b) by software running on and/or distributed by a social-networking website in conjunction with the software running on the ad-serving website.

In operation 201 of the process shown in FIG. 2, software (e.g., software running on a social-networking website with an ad-serving service) transmits data associated with an online ad (including an identifier for the online ad) over a network to a financial-services website that maintains a payment accounts (e.g., associated with debit, credit, or other bank cards, bank accounts, electronic-payment services, mobile-payment services, etc.) for account-holder users of the social-networking website. In an example embodiment, each account-holder member has expressly given the financial-services website limited authority to use data associated with a payment account for the account-holder member (e.g., including data as to each purchase made with the payment account by the member and/or the authorized agents of the member). For example, the limited authority might include authority to use the data associated with the payment account for the account-holder member to target ads on the social-networking website, without sharing the data itself with the social-networking website. In an alternative example embodiment, the limited authority might include authority to use the data to target ads on the social-networking website, including sharing the data itself with the social-networking website.

In operation 202, the second operation shown in FIG. 2, the software (e.g., software running on a social-networking website with an ad-serving service) receives data from the financial-services website that includes a ranking of account-holder members who have been identified as potential targets for the online ad, as identified by its identifier. Then in operation 203, that software (e.g., software running on a social-networking website with an ad-serving service) presents the online ad (e.g., using a GUI view displayed by a client browser or client app) to some or all of account-holder members who have been identified as potential targets for the online ad (as identified by its identifier).

In operation 201, the financial-services website might receive limited authority from an account-holder member that includes authority to use data associated with a payment account for the account-holder member to target ads on the social-networking website, without sharing the data itself with social-networking website. Such limited authority might be viewed as advantageous by an account-holder member, since the data associated with the payment account for the account-holder member never leaves the financial-services website and therefore never becomes a security risk (e.g., which can be obtained by hackers) or a privacy risk (e.g., subject to unintentional disclosure) on the social-networking website. In an example embodiment, where the data associated with a payment account for the account-holder member is not shared with the social-networking website, the financial-services website might run a client program or module distributed by the social-networking website and/or an ad-serving website to determine the account-holder members who are potential targets for the online ad, as depicted in FIGS. 1A and 1B.

In operation 203, the software presents the online ad (e.g., using a GUI view displayed by a client browser or client app) to some or all of account-holder members who have been identified as potential targets for the online ad. Examples of such GUI views are provided below. In an example embodiment, that software might further filter the account-holder members identified as potential targets for the online ad using social-networking data. Such social-networking data might include (a) profile, stream, or search data for a member who is an account-holder (e.g., including personalization data, signals such as likes, shares, page or image views, comments, etc.) and/or (b) profile, stream, or search data for an entity who is a merchant, in an example embodiment. That social-networking data might be gathered by the social-networking website offline or nearline, using some or all of the techniques described in the article by Xavier Amatriain and Justin Basilico, “System Architectures for Personalization and Recommendation” (Mar. 27, 2013), included in the end matter to the provisional applications incorporated herein by reference.

For example, if the online ad is for a car and the social-networking data (e.g., a comment posted to a timeline) indicates that a account-holder member identified as a potential target for the online ad has recently purchased a car using financing other than the payment account, the software might determine that the online ad should not be presented to that account-holder member.

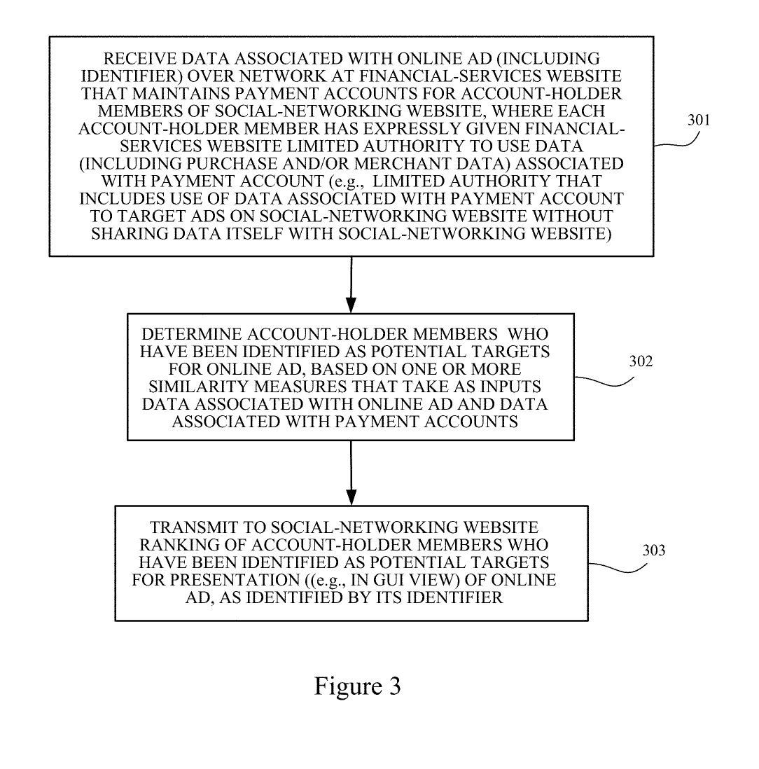

FIG. 3 is a flowchart diagram that illustrates a process for identifying targets for ads on a social-networking website based on data associated with a payment account maintained by a financial-services website, in accordance with an example embodiment. As discussed above, this process might be performed by software running on a financial-services website, e.g., when the limited authority from an account-holder member to a financial-services website includes authority to use data associated with a payment account for the account-holder member to target ads on the social-networking website, without sharing the data itself with the social-networking website. In an alternative example embodiment, some or all of the operations of this process might be performed by software running on or distributed by the social-networking website and/or the ad-serving website, e.g., when the limited authority from an account-holder member to a financial-services website includes authority to share the data itself with the social-networking website and/or the ad-serving website.

In operation 301 of the process shown in FIG. 3, software running on a financial-services website receives data associated with an online ad, including an identifier for the online ad. The financial-services website maintains payment accounts (e.g., associated with debit, credit, or other bank cards, bank accounts, electronic-payment services, mobile-payment services, etc.) for account-holder members of the social-networking web site. In an example embodiment, each account-holder member has expressly given the financial-services website limited authority to use data associated with a payment account for the account-holder member (e.g., limited authority that includes use of the data associated with the payment account for the account-holder member to target ads on the social-networking website without sharing the data itself with the social-networking website). In operation 302, the software determines account-holder members who have been identified as potential targets for the online ad, based on a similarity measure that takes as inputs the data associated with the online ad and the data associated with the payment accounts. Then in operation 303, the software transmits to the social-networking website a ranking of account-holder members who have been identified as potential targets for presentation (e.g., in a GUI view) of the online ad, as identified by its identifier.

In operation 302, the software determines account-holder members who have been identified as potential targets for the online ad, based on a similarity measure that takes as inputs the data associated with the online ad and the data associated with payment accounts. In an example embodiment, the data associated with the online ad and the data associated with a payment account might each be represented in whole or in part as a set of words or terms. In such an example embodiment, the similarity measure might Jaccard coefficient. In an alternative example, the data associated with the online ad and the data associated with a payment account might each be represented in whole or in part as a vector of words or terms. In such an example embodiment, the similarity measure might be cosine similarity. In other example embodiments, other similarity measures, representations, and/or techniques (or a combination or hybrid thereof) might be used, as described in the excerpt from Rajaraman et al., “Mining of Massive Datasets” (2012) and the presentation by Schelter et al. “Scalable Similarity-Based Neighborhood Methods with MapReduce (2012), included in the end matter to the provisional applications incorporated herein by reference. It will be appreciated that this determination need not be done in real-time, though real-time or near real-time performance might be possible in some implementations, e.g., using structured data as explained in Melnik et al., “Dremel: Interactive Analysis of Web-Scaled Datasets”, also included in the end matter to the provisional applications incorporated herein by reference.

In an example embodiment, the determination of account-holder members who have been identified as potential targets for the online ad might be a weighted determination (e.g., based on business logic and/or based on machine-learning functionality with, for example, regression coefficients). For example, if the online ad is for a computer and the and the data associated with a payment account indicates that a account-holder member made a sizable purchase (e.g., hundreds of dollars) from a computer retailer within a relatively recent period of time (e.g., in terms of the mean/median time of ownership for the computer or all computers), the software might discount the similarity score for that account-holder member. Likewise, if the online ad is for a high-end restaurant in a particular geographic location and the data associated with a payment account indicates that most recent restaurant purchases by the account-holder member were for relatively small amounts (e.g., twenty dollars or less) at low-end restaurants in that geographic location, the software might discount the similarity score for that account-holder member. Or, if the online ad is for a computer peripheral and the data associated with the payment account for the account-holder member indicates that the account-holder member recently made a significant purchase (e.g., hundreds of dollars) from a computer retailer, the software might boost the similarity score for that account-holder member.

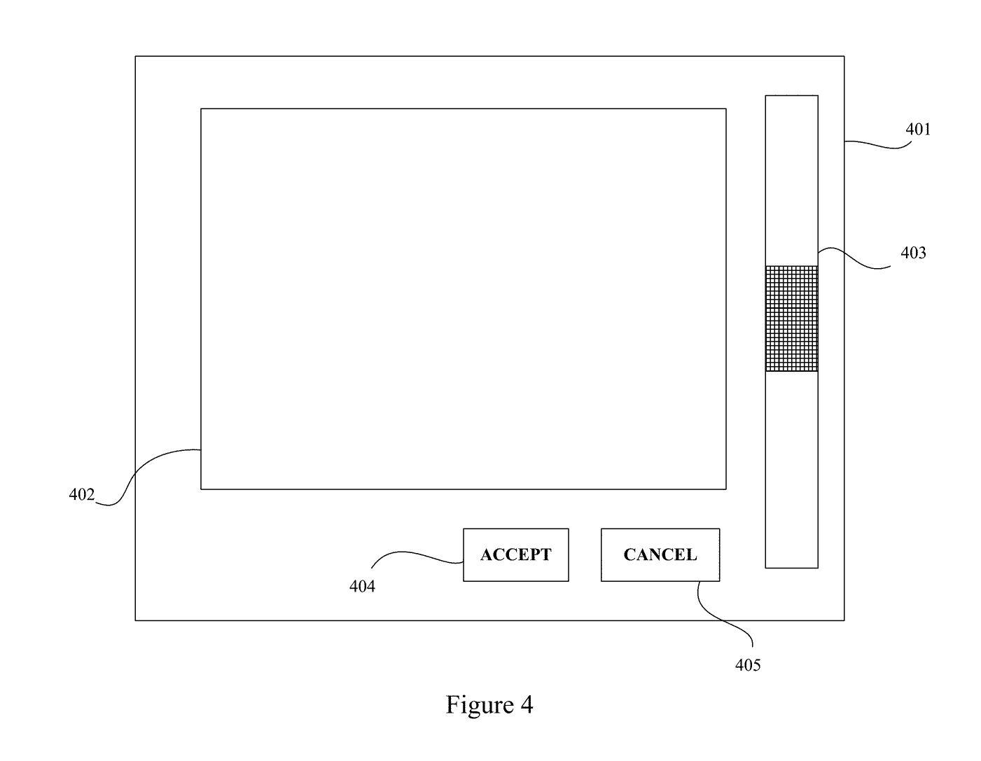

FIG. 4 is a dialog in a graphical user interface (GUI) that might be used by a financial-services website to obtain limited authority to use data associated with a payment account for the account-holder member of a social-networking website, in accordance with an example embodiment. As depicted in FIG. 4, dialog 401 includes a text box 402 which would include a verbal description of the limited authority, e.g., authority to use the data associated with a payment account for the account-holder member to target online ads on the social-networking website, without sharing the data itself with the social-networking website. Further, the verbal description might explain how the data associated with a payment account is used to target the online ads, e.g., through anonymous matching (e.g., through a similarity determination) of the data associated with the payment account and the data associated with the online ad performed by a machine (or computer) rather than a human. And the verbal description might explain that the limited authority can be revoked at any time. Dialog 401 also includes a scroll bar 403 and a button 404 labeled “ACCEPT” and a button 405 labeled “CANCEL”. In an example embodiment, button 404 might only become active if the member has scrolled to the end of the verbal description in text box 402, using scroll bar 403.

It will be appreciated that compliance with financial privacy laws and regulations or industry standards might involve the use of additional procedural safeguards (e.g., a model privacy form, an electronic signature such as EchoSign, a witnessed signature, etc.), when obtaining the limited authority to use the data associated with a payment account for an account-holder member.

In an example embodiment, the financial-services website might provide compensation to obtain the limited authority to use the data associated with a payment account for an account-holder member of a social-networking website. The compensation might take the form of a non-cash reward, such as the ThankYou points that can be earned by CitiCard holders. Or, where financial laws and regulations allow, the compensation might involve a grace period for making a payment under the terms of the payment account. For example, the duration of the grace period might be determined by the duration of the limited authority (e.g., one day of grace period for every month of limited authority). Or the grace period might be a recurring grace period of a set duration (e.g., three days) that is earned periodically (e.g., every month) by not revoking the limited authority. In this regard, it will be appreciated that the financial-services website will receive compensation from the social-networking website and/or the third-party ad-serving website, e.g., on the basis of click-throughs, shares, likes, views, view times, or other interaction with the online ad. It will also be appreciated that such interactions with the online ad might be used to provide implicit feedback to business logic and/or to machine-learning functionality (e.g., a regression model or decision trees) associated with the weighted determination of account-holder members who have been identified as potential targets for the online ad.

In an example embodiment, the financial-services website might also pay compensation to the merchants identified in the data associated with a payment account, e.g., in order to obtain limited authority to use information about the merchant (e.g., a merchant or entity profile) or in order to obtain more details about the purchases made by account-holder members (e.g., an itemized receipt from a merchant who is a grocery store or a restaurant), where permitted by applicable laws and regulations.

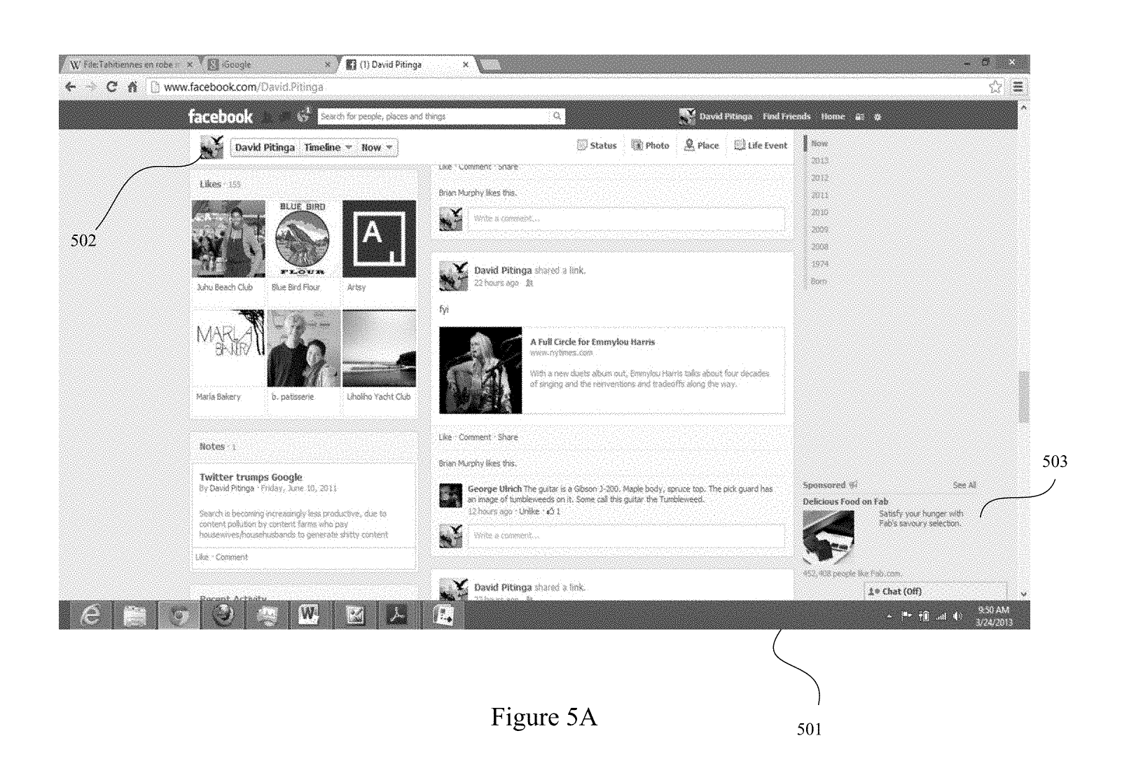

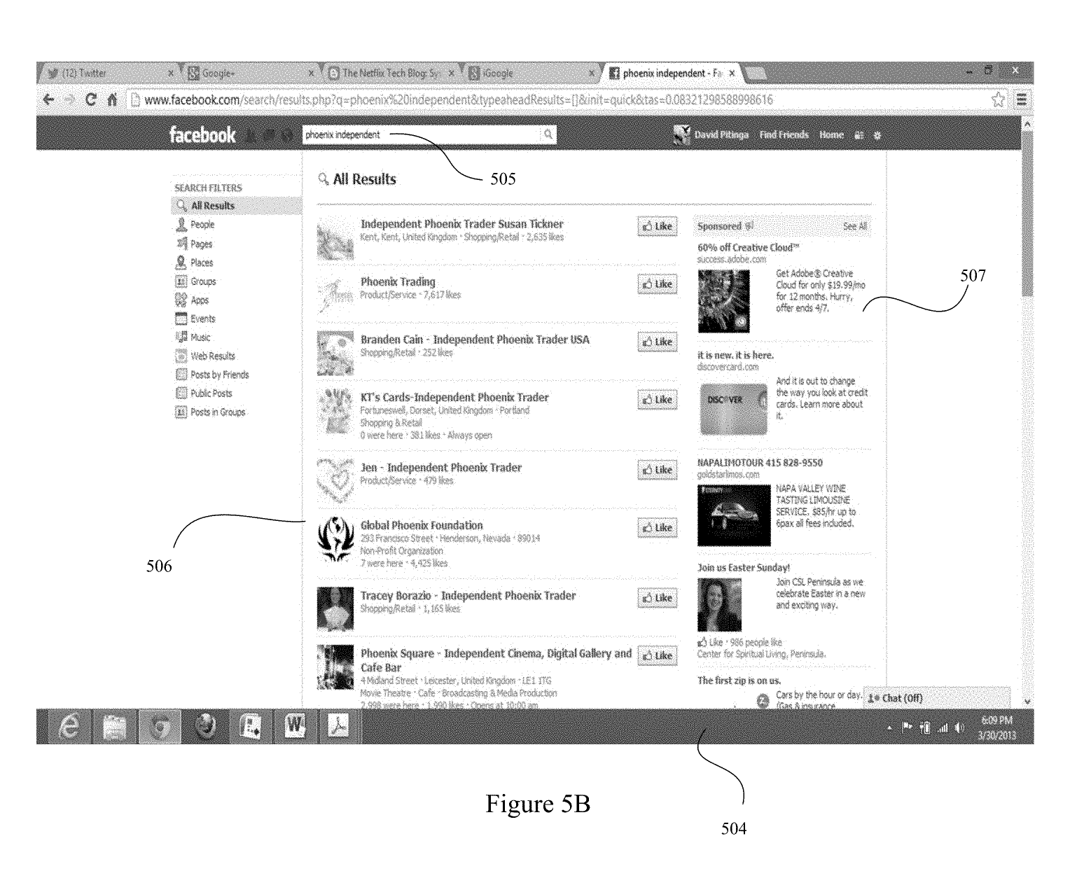

FIG. 5A is a GUI view, including an online ad, for a profile on a social-networking website (e.g., Facebook), in accordance with an example embodiment. As shown in this figure, GUI view 501 is associated with a profile represented by profile image 502. GUI view 501 includes an online ad 503, which could have been presented using the processes described above.

FIG. 5B is a GUI view, including an online ad, for search results on a social-networking website (e.g., Facebook), in accordance with an example embodiment. As shown in this figure, GUI view 504 shows search results 506 resulting from a query 505 which reads “phoenix independent”. GUI view 504 includes an online ad 507, which could have been presented using the processes described above. In the example embodiment depicted, online ad 507 appears to be unrelated to query 505 and/or search results 506. In an alternative example embodiment, the online ad might be related to query 505 and/or search results 506, e.g., the ad might be for a concert by a band called “Phoenix” at a nightclub called The Independent.

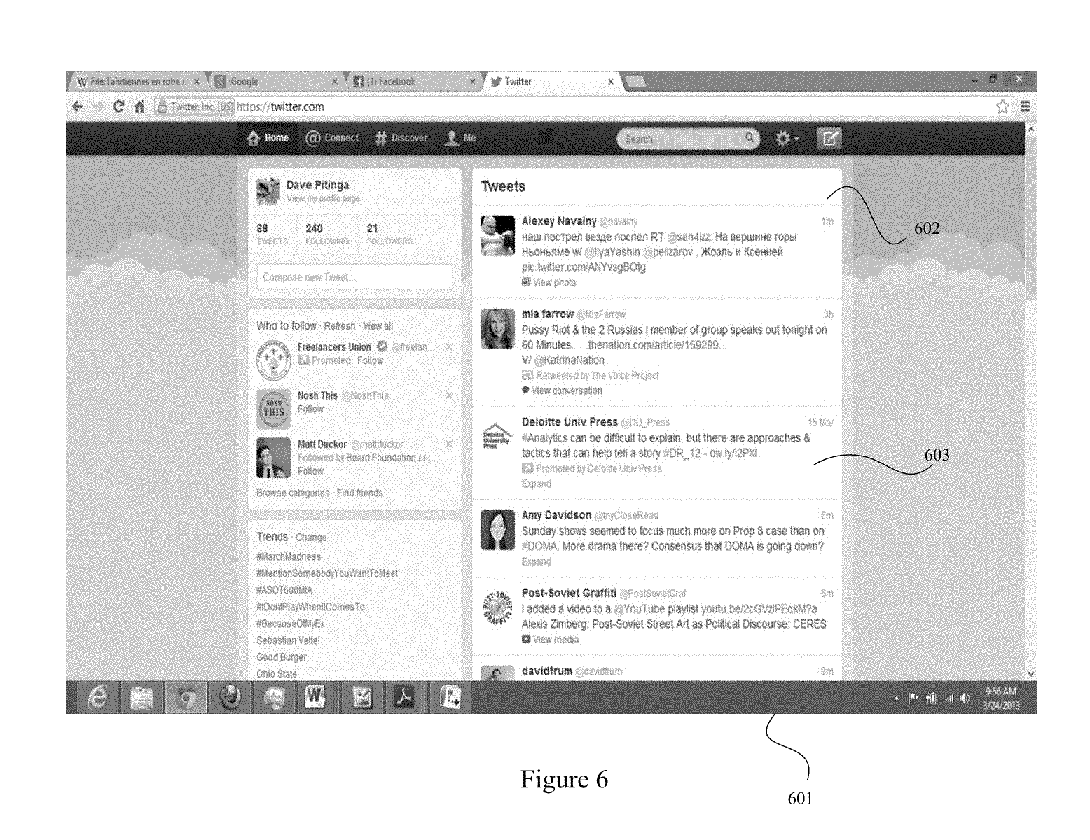

FIG. 6 is a GUI view, including an online ad, for a timeline (or stream, newsfeed, etc.) on a social-networking website (e.g., Twitter), in accordance with an example embodiment. As shown in this figure, GUI view 601 includes a timeline 602, which is a series of content posts which might be ordered on the basis of recency with the most recent post at the top of the GUI view 601 and the least recent post at the bottom of the GUI view 601. Alternatively, the content posts in the timeline might be ordered on the basis of click-worthiness, interestingness, relevance, etc., based on an algorithm that uses a metric such graph centrality (e.g., PageRank) or weighted graph centrality (e.g., EdgeRank). GUI view 601 includes online ad 603, which is inserted amongst the content posts in timeline 602 and which could have been presented using the processes described above. It will be appreciated that inserted ads such as online ad 603 are useful for presentation on mobile devices such as smartphones.

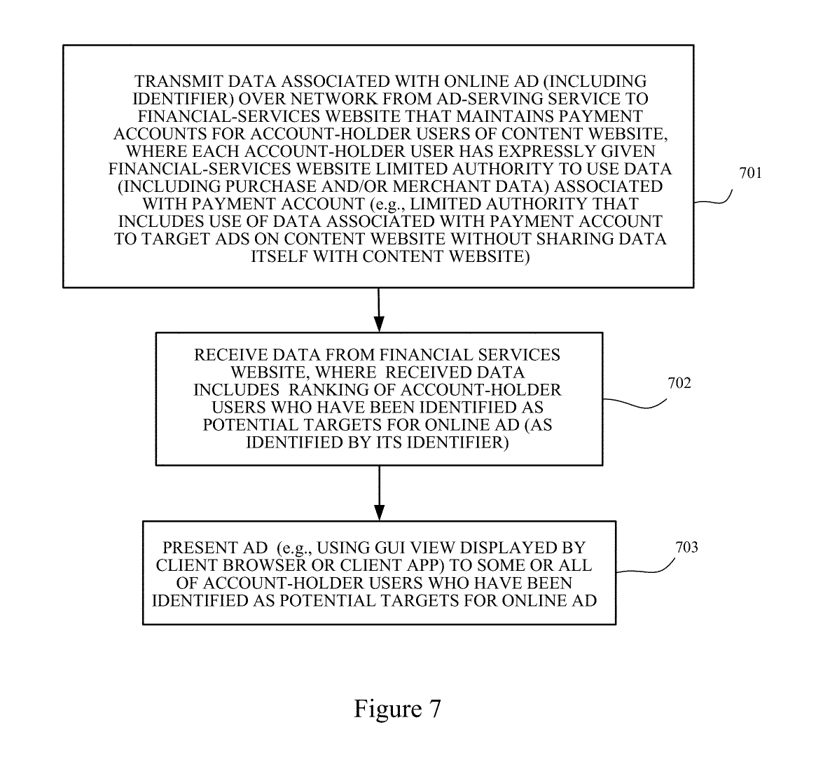

FIG. 7 is a flowchart diagram that illustrates a process for serving ads on a content website based on data with a payment account maintained by a financial-services website, in accordance with an example embodiment. In an example embodiment, all of the operations in the process might be performed by software running on or distributed by (e.g., a client application or app) a content website, e.g., a content website (such as Yahoo!) with an ad-serving service as depicted in FIG. 1B. In an alternative example embodiment, the first operation in the process shown in FIG. 7 might be performed by software running on an ad-serving website which is not a part of a content website, as depicted in FIG. 1A. In that example embodiment, the second and third operations might be performed (a) by software running on and/or distributed by a content website or (b) by software running on and/or distributed by a content website in conjunction with the software running on the ad-serving website.

In operation 701 of the process shown in FIG. 2, software (e.g., software running on a content website with an ad-serving service) transmits data associated with an online ad (including an identifier for the online ad) over a network to a financial-services website that maintains payment accounts (e.g., associated with debit, credit, or other bank cards, bank accounts, electronic-payment services, mobile-payment services, etc.) for account-holder users of the content website. In an example embodiment, each account-holder user has expressly given the financial-services website limited authority to use a data associated with the payment account for the account-holder user (e.g., including data as to each purchase made with the payment account by the user and/or the authorized agents of the user). For example, the limited authority might include authority to use the data associated with the payment account for the account-holder user to target ads on the content website, without sharing the data itself with the content website. In an alternative example embodiment, the limited authority might include authority to use the data to target ads on the content website, including sharing the data itself with the content website. Here again, the account-holder users (and the merchants associated with the payment accounts) might be compensated by the financial-services website for this limited authority to the data and it might be obtained using a GUI dialog similar to that shown in FIG. 4.

In operation 702, the second operation shown in FIG. 2, the software (e.g., software running on a social-networking website with an ad-serving service) a content website receives data from the financial-services website. The received data includes a ranking of account-holder users who have been identified as potential targets for the online ad, as identified by its identifier. Then in operation 703, that software (e.g., software running on a social-networking website with an ad-serving service) presents the online ad (e.g., using a GUI view displayed by a client browser or client app) to some or all of the account-holder users who have been identified as potential targets for the online ad.

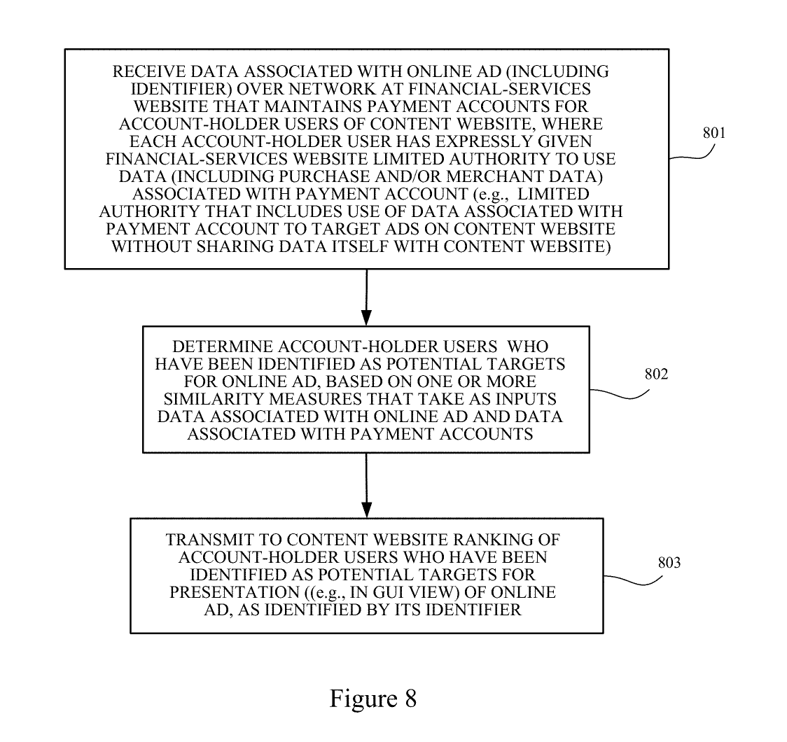

FIG. 8 is a flowchart diagram that illustrates a process for identifying targets for ads on a content website based on data associated with a payment account maintained by a financial-services website, in accordance with an example embodiment. As discussed above, this process might be performed by software running on a financial-services website, e.g., when the limited authority from an account-holder user to a financial-services website includes authority to use data associated with a payment account for the account-holder user to target ads on the content website, without sharing that data itself with the content website. In an alternative example embodiment, some or all of the operations of this process might be performed by software running on or distributed by the content website and/or the ad-serving website, e.g., when the limited authority from an account-holder user to a financial-services website includes authority to share the data itself with the content website.

In operation 801 of the process shown in FIG. 8, software (e.g., software running on a content website with an ad-serving service) receives data associated with an online ad, including its identifier. The financial-services website maintains payment accounts (e.g., associated with debit, credit, or other bank cards, bank accounts, electronic-payment services, mobile-payment services, etc.) for account-holder users of the content website. In an example embodiment, each account-holder user has expressly given the financial-services website limited authority to use data associated with a payment account for the account-holder user (e.g., limited authority that includes use of the data associated with a payment account for the account-holder user to target ads on the content website without sharing the data itself with the content website). In operation 802, the software determines account-holder users who have been identified as potential targets for the online ad, based on a similarity measure that takes as inputs the data associated with the online ad and the data associated with the payment accounts. Then in operation 803, the software transmits to the content website a ranking of account-holder users who have been identified as potential targets for presentation (e.g., in a GUI view) of the online ad, as identified by its identifier.

In operation 802, the software determines account-holder users who have been identified as potential targets for the online ad, based on a similarity measure that takes as inputs the data associated with the online ad and the data associated with the payment accounts. In an example embodiment, the data associated with the online ad and the data associated with a payment account might each be represented in whole or in part as a set of words or terms. In such an example embodiment, the similarity measure might Jaccard coefficient. In an alternative example, the data associated with the online ad and the data associated with a payment account might each be represented in whole or in part as a vector of words or terms. In such an example embodiment, the similarity measure might be cosine similarity. In other example embodiments, other similarity measures, representations, and/or techniques (or a combination or hybrid thereof) might be used. Here again, it will be appreciated that this determination need not be done in real-time, though real-time or near real-time performance might be possible in some implementations. And, in an example embodiment, the determination of account-holder users who have been identified as potential targets for the online ad might be a weighted determination (e.g., based on business logic and/or based on machine-learning functionality with, for example, regression coefficients).

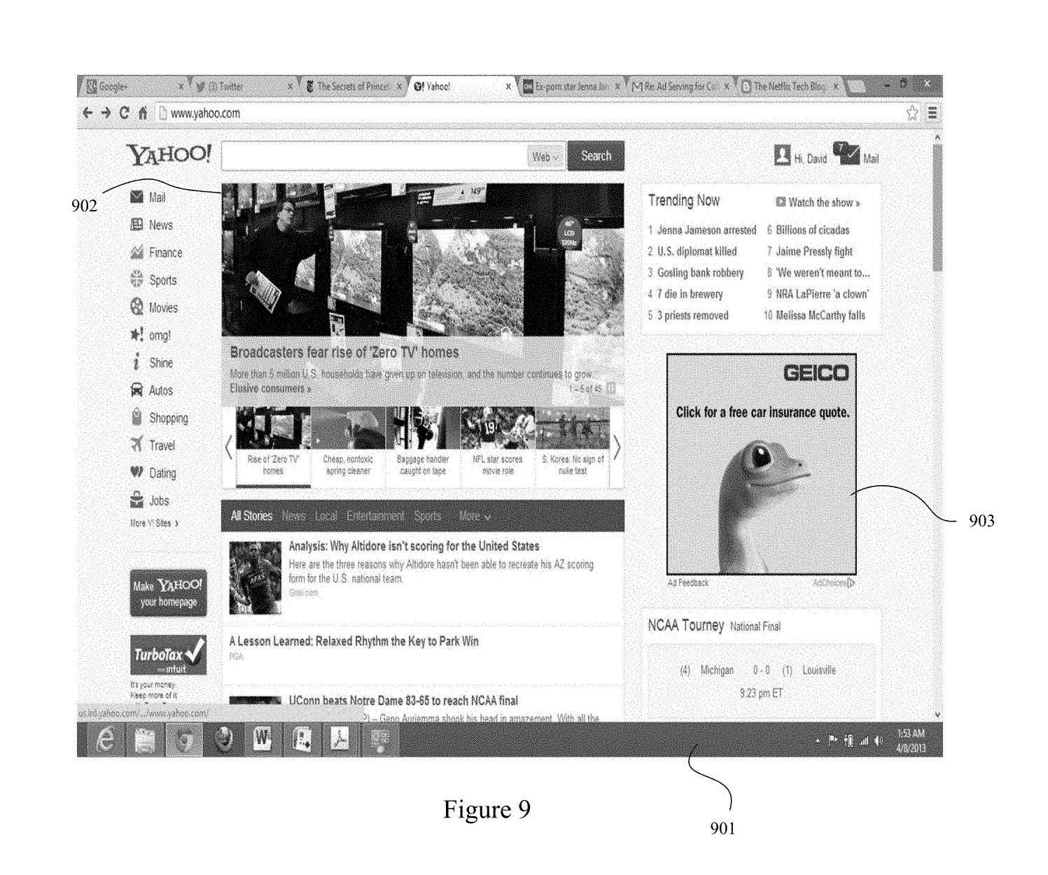

FIG. 9 is a GUI view, including an online ad, for a content stream on a content website, in accordance with an example embodiment. As shown in this figure, GUI view 901 includes a content stream 902, which is a series of content posts which might be ordered on the basis of recency with the most recent post at the top of the GUI view 901 and the least recent post at the bottom of the GUI view 901. Alternatively, the content posts in the timeline might be ordered on the basis of click-worthiness, interestingness, relevance, etc., based on an algorithm that uses a metric such graph centrality or weighted graph centrality. GUI view 901 includes online ad 903, which could have been presented using the processes described above.

Returning to FIGS. 1A and 1B, personal computing devices 102 and 103 might be laptops or other personal computers. In that event, personal computing devices 102 and 103 and the servers in website 104, 107, and 111 might include (1) hardware consisting of one or more microprocessors (e.g., from the x86 family or the PowerPC family), volatile storage (e.g., RAM), and persistent storage (e.g., a hard disk or solid-state drive), and (2) an operating system (e.g., Windows, Mac OS, Linux, Windows Server, Mac OS Server, etc.) that runs directly or indirectly (e.g., through virtualization software) on the hardware. Or the operating system for the servers might be replaced by a hypervisor or other virtualization software. Alternatively, personal computing devices 102 and 103 might be smartphones, tablet computers, or other mobile devices that include (1) hardware consisting of one or more low-power microprocessors (e.g., from the ARM family), volatile storage (e.g., RAM), and persistent storage (e.g., flash memory such as microSD) and (2) an operating system (e.g., Symbian OS, RIM BlackBerry OS, iPhone OS, Palm webOS, Windows Mobile, Android, Linux, etc.) that runs on the hardware.

Also in an example embodiment, personal computing devices 102 and 103 might include a web browser as an application program or part of an operating system. Examples of web browsers that might execute on personal computing devices 102 and 103 if they are laptops or other personal computers include Internet Explorer, Mozilla Firefox, Safari, and Google Chrome. Examples of browsers that might execute on personal computing devices 102 and 103 if they are smartphones, tablet computers, or other mobile devices include Safari, Mozilla Firefox, Android Browser, and Palm webOS Browser. It will be appreciated that members/users of website 109 might use browsers to communicate with software running on the servers at website 109 or financial-services website 104. Alternatively, members/users of website 109 might use other application programs to communicate with software running on the servers at the website. For example, if the personal computing devices 102 is a smartphone, tablet computer, or other mobile device, members/users might use an app or a hybrid app (e.g., an app written in Objective C or Java that includes embedded HTML5) to communicate with software running on the servers at website 109 or financial-services website 104. It will be appreciated that a client application program for a mobile device is often referred to as an “app”. Similarly, an advertiser using personal computing device 103 might communicate with ad-serving website 107 using a browser or an app.

With the above embodiments in mind, it should be understood that the inventions might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the inventions are useful machine operations. The inventions also relate to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The inventions can also be embodied as computer readable code on a computer-readable medium. The computer-readable medium is any data storage device that can store data, which can thereafter be read by a computer system. Examples of the computer-readable medium include hard drives, network attached storage (NAS), read-only memory, random-access memory, CD-ROMs, CD-Rs, CD-RWs, DVDs, Flash, magnetic tapes, and other optical and non-optical data storage devices. The computer-readable medium can also be distributed over a network coupled computer systems so that the computer readable code is stored and executed in a distributed fashion.

Although example embodiments of the inventions have been described in some detail for purposes of clarity of understanding, it will be apparent that certain changes and modifications can be practiced within the scope of the following claims. For example, the determination as to potential targets for ads lends itself to solution as an optimization problem. And consequently, it might be well-suited for performance by a quantum computer (e.g., manufactured by D-Wave Systems) rather than a traditional computer. Further, the operations described above can be ordered, modularized, and/or distributed in any suitable way, e.g., as server software, client software, or a combination of both. Or the operations might be performed by software, firmware, hardware, and/or wetware. Accordingly, the present embodiments are to be considered as illustrative and not restrictive, and the inventions are not to be limited to the details given herein, but may be modified within the scope and equivalents of the following claims. In the following claims, elements and/or steps do not imply any particular order of operation, unless explicitly stated in the claims or implicitly required by the disclosure.

What is claimed:

1-19. (canceled)

20. A method, comprising operations of:
receiving data associated with an online ad over a network at a financial-services website that maintains a payment account for each of a plurality of account-holder members of a social networking website, wherein each of the plurality of account-holder members has expressly given the financial-services website limited authority to use data associated with the payment account, and wherein the limited authority includes use of the data associated with the payment account to target ads on the social-networking website without sharing the data with the social-networking website;
determining, in real-time or near real-time using Dremel technology, one or more account-holder members who have been identified as potential targets for the online ad, based at least in part on a similarity measure that is cosine similarity that takes as input the data associated with the online ad and the data associated with each of the payment accounts; and
transmitting to the social-networking website a ranking of the one or more account-holder members who have been identified as potential targets for presentation of the online ad.
